(19) United States
(12) Patent Application Publication
(10) Pub. No.: US 2026/0169707 A1
(43) Pub. Date: Jun. 18, 2026

(54) USER BEHAVIOR-BASED AI TEST CODE GENERATION SYSTEM AND METHOD AND PROGRAM PERFORMING THE SAME

(71) Applicant: INSWAVE CO., LTD., Seoul (KR)

(72) Inventors: Se Yong EO, Seoul (KR); Woog Lae KIM, Seoul (KR)

(21) Appl. No.: 19/420,581

(22) Filed: Dec. 15, 2025

(30) Foreign Application Priority Data
Dec. 13, 2024 (KR) 10-2024-0185467

(51) Int. Cl. G06F 8/35

(52) U.S. Cl. CPC G06F 8/35

(57) ABSTRACT

User behavior-based AI test code generation system and method and a program performing the same disclosed. A non-transitory computer-readable medium storing computer executable instructions for performing a user behavior-based AI test code generation method when executed by a computer, wherein the computer program causes the computer to perform the following steps: recording a UI interaction related to a user behavior on an execution screen of software to be tested; analyzing a UI source of the software; inputting the recorded user behavior and an analysis result of the UI source to generate a test scenario through an LLM; and converting the test scenario into a test code corresponding to an executable test case.

### CROSS-REFERENCE TO RELATED APPLICATION

The present application claims priority under 35 U.S.C. § 119(a) to Korean application number 10-2024-0185467, filed on Dec. 13, 2024, in the Korean Intellectual Property Office, which is incorporated herein by reference in its entirety.

### BACKGROUND

The present invention relates to a user behavior-based AI test code generation system and method and a program performing the same.

In a software development process, testing is an essential step for quality assurance. In particular, user interface (UI) testing requires significant time and efforts because it must take into account complex and diverse scenarios. Therefore, efforts are being made to automate such tests.

However, current test automation methods have the following problems.

First, there are inherent limitations in manually preparing test scripts. The process of developers or testers manually creating test cases requires significant time and human resources (resource-intensive). Since only scenarios anticipated by the developer are tested, actual user behavior patterns across diverse user environments or devices are not reflected (lack of real-world user simulation). Moreover, unexpected user scenarios or edge cases are easily overlooked (incomplete coverage of edge cases).

Next, a script recording program also presents the following issues. Generated scripts often do not operate stably in an actual test environment (unstable execution in real-world test conditions). For modification or extension of the generated scripts, a specialized script developer rather than a tester is required (high maintenance overhead). Moreover, simply recording actions makes it difficult to capture the intent or significance of the test (inability to reflect test objectives).

In addition, there is a difficulty in responding to changes in UI. Each time the UI is modified, the test code must be manually updated. This is time-consuming and has a high risk of defects.

Due to these problems, there are inherent limitations in assuring the quality of software, and issues that may arise in actual usage environments are frequently not detected in advance.

The matters described in this section are provided solely for the purpose of understanding the background of the invention, and should not be construed as admitted prior art known to a person having ordinary skill in the art.

### SUMMARY

The present invention is intended to provide a user behavior-based AI test code generation system and method and a program performing the same, which can automatically generate test codes by utilizing artificial intelligence (AI) based on actual actions of a user.

The present invention is intended to provide a user behavior-based AI test code generation system and method and a program performing the same, which automatically convert user behavior into test codes to minimize manual work, enable testing based on actual user behavior, can flexibly respond to UI changes, and enable improved test coverage and continuous improvement.

Other objectives of the present invention will become more apparent through the embodiments described below.

According to one aspect of the present invention, there is provided a non-transitory computer-readable medium storing computer executable instructions for performing a user behavior-based AI test code generation method when executed by a computer, wherein the computer program causes the computer to perform the following steps: recording a UI interaction related to a user behavior on an execution screen of software to be tested; analyzing a UI source of the software; inputting the recorded user behavior and an analysis result of the UI source to generate a test scenario through an LLM; and converting the test scenario into a test code corresponding to an executable test case.

In the step of generating the test scenario, a sequence of the user behaviors may be analyzed by utilizing a Recurrent Neural Network (RNN) and a transformer model, and the meaningful test scenario is extracted.

In the step of generating the test scenario, an intention and a context of the user behavior may be understood using a natural language processing technique.

In the step of generating the test scenario, a priority of the test scenario may be determined by analyzing a pattern and the intention of the user behavior.

In the step of analyzing the UI source, at least one of a structure, an attribute, and an event handler of an UI component constituting the execution screen may be extracted, mapped to a UI source code, parsed, and analyzed.

The user behavior may include at least one of a mouse click, a keyboard input, a touch, and a gesture. The step of recording the user behavior may collect detailed information of at least one of coordinates, pressure, speed, and timestamp of each action according to the user behavior.

The user behavior-based AI test code generation method may further include analyzing and optimizing a coverage of the test case, and utilizing a reinforcement learning algorithm to generate an unexpected user scenario to be tested.

The coverage may be at least one of a ratio of executed code lines and a ratio of called functions.

The user behavior-based AI test code generation method may further include at least one of: visualizing the generated test scenario and the test case; and outputting a test execution result through a dashboard interface.

According to another aspect of the present invention, there is provided a user behavior-based AI test code generation system, including a user behavior recording module configured to record a UI interaction related to a user behavior on an execution screen of software to be tested; a UI source analysis module configured to analyze a UI source of the software; a test scenario generation engine configured to input the recorded user behavior and an analysis result of the UI source to generate a test scenario through an LLM; and a test case code generation module configured to convert the test scenario into a test code corresponding to an executable test case.

The user behavior-based AI test code generation system may further include an AI-based optimization and expansion module configured to analyze and optimize a coverage of the test case, and utilize a reinforcement learning algorithm to generate an unexpected user scenario to be tested.

The user behavior-based AI test code generation system may further include a result visualization and reporting module configured to visualize the generated test scenario and the test case, and output a test execution result through a dashboard interface.

Other aspects, features, and advantages other than those described above will become apparent from the following drawings, claims, and detailed description of the invention.

According to embodiments of the present invention, it is advantageous in that test codes can be automatically generated by utilizing artificial intelligence based on actual user behavior.

In addition, it is advantageous that user behavior is automatically converted into test codes to minimize manual work, testing based on actual user behavior is enabled, flexible response to UI changes is possible, and test coverage is improved and continuous improvement is possible.

The effects obtainable from the present invention are not limited to the effects mentioned above, and other effects not mentioned will be clearly understood by those skilled in the art in the field to which the present invention belongs from the following description.

### BRIEF DESCRIPTION OF DRAWINGS

FIG. 1 exemplarily illustrates a software test automation system according to one embodiment of the present invention;

FIG. 2 is a flowchart of a software test automation method according to one embodiment of the present invention.

FIG. 3 exemplarily illustrates a user behavior-based AI test code generation system according to one embodiment of the present invention;

FIG. 4 is a flowchart of a user behavior-based AI test code generation method according to one embodiment of the present invention;

FIG. 5 exemplarily illustrates a process of generating a user behavior-based AI test code;

FIGS. 6 and 7 exemplarily illustrate a test target screen, recorded user behavior data, and a written AI test code; and

FIG. 8 exemplarily illustrates a configuration of a system according to one embodiment of the present invention.

### DETAILED DESCRIPTION

The invention can be modified in various forms and specific embodiments will be described below and illustrated with accompanying drawings. However, the embodiments are not intended to limit the invention, but it should be understood that the invention includes all modifications, equivalents, and substitutions belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these elements should not be limited due to these terms. These terms will be used to distinguish one element from another element.

The terms used in the following description are intended to merely describe specific embodiments, but not intended to limit the invention. The singular forms are intended to include the plural forms unless the context clearly dictates otherwise. In the present specification, the terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

In this disclosure, the term “unit” refers to a unit implemented by hardware, a unit implemented by software, or a unit implemented by a combination of both. A single unit may be realized using two or more hardware components, and conversely, two or more units may be realized by a single hardware component. In addition, the term “unit” is not meant to be limited to software or hardware, and the “unit” may be configured to reside on an addressable storage medium or may be configured to execute one or more processors. Thus, in one example, “˜unit” may include components, such as software components, object-oriented software components, class components, and task components, as well as processes, functions, properties, procedures, subroutines, segments of program code, drivers, firmware, microcode, circuits, data, databases, data structures, tables, arrays, and variables. The functionality provided within the components and “˜units” may be combined into fewer components and “˜units” or further separated into additional components and “˜subunits”. In addition, the components and “˜units” may be implemented to cause one or more CPUs in the device to execute.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In the following description, reference is made to the accompanying drawings, wherein like or corresponding reference numerals are used to designate like or corresponding elements, and redundant explanations thereof will be omitted. In describing the present invention, detailed descriptions of well-known technologies that may unnecessarily obscure the gist of the invention will be omitted.

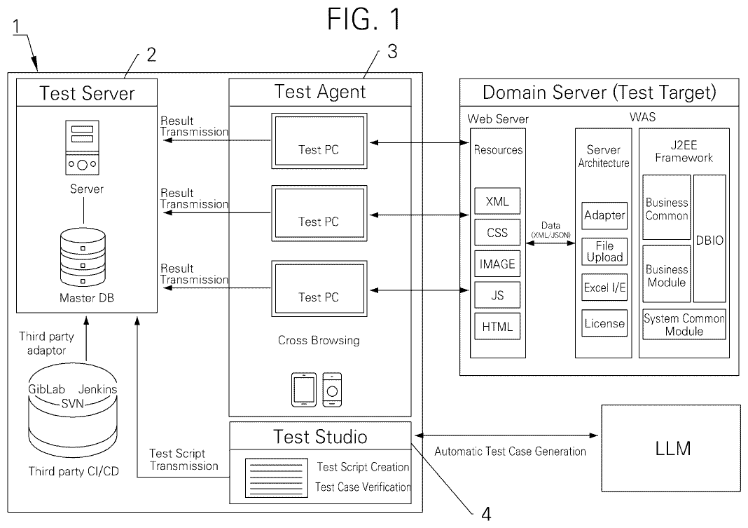

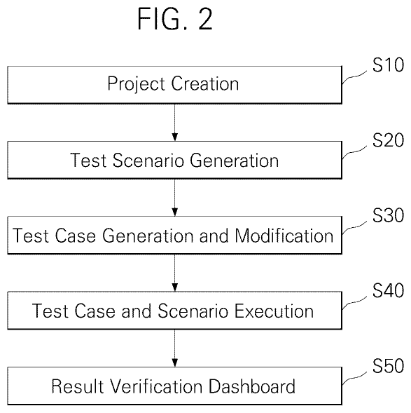

FIG. 1 exemplarily illustrates a software test automation system according to one embodiment of the present invention, and FIG. 2 is a flowchart of a software test automation method according to one embodiment of the present invention.

The software test automation system 1 according to one embodiment of the present invention has an End to End (E2E) test framework structure that verifies the entire software from the beginning to the end together with external interface integration. As used herein, the software may include a computer program, an application, and the like.

Referring to FIG. 1, the software test automation system 1 may include a test server 2, a test agent 3, and a test studio 4.

The test server 2 may be configured to manage a test scenario regarding software testing. And the test server 2 may be configured to provide test related information to a user (e.g., an administrator) through a dashboard. Also, the test server 2 may be configured to perform user management.

The test agent 3 may be configured to directly perform a test on a test target. The test target may be a domain server including a web server and a web application server (WAS).

And the test agent 3 may be configured to collect test information and transmit the result to the test server 2.

A development environment, a test environment, an operation environment, and the like may be linked to the test agent 3.

The test studio 4 may be configured to generate a test case. The test studio 4 may be configured to learn user behavior and generate the test case through artificial intelligence (AI).

Also, the test studio 4 may be configured to generate a test script through recording. The recording may be performed not only automatically but also manually. The script regarding the generated test case may be transmitted to the test server 2.

Also, the test studio 4 may be configured to verify the test case.

Referring to FIG. 2, the software test automation method performed in the software test automation system 1 is illustrated.

In S10, a project is created, and a user is registered.

In S20, a test scenario is generated.

The test scenario relates to an execution screen of the software to be tested, and may be generated through analysis of the execution screen. The test scenario may be a scenario of inputting data for a test, clicking a button, and testing whether an event operates correctly.

For example, in the case of software related to corporate payment collection, the following test scenario may be created.

### 1. Click the Search Button for Corporate Payment Records

Enter “12345” in the “Customer Number” input field.
Click the “Search” button.
Verify that the search results are displayed in the grid.

### 2. Click the Excel Download Button

Click the “Excel Download” button.
Verify that a download popup appears.

### 3. Click the Save Button for Corporate Payment Details

Enter “2024 Dec. 1” in the “Scheduled Payment Date” input field.
Enter “2024 Dec. 2” in the “Payment Date” input field.
Select “Cash” from the “Payment Type” dropdown.
Enter “10000” in the “Incorporated Balance before Collection” input field.
Enter “5000” in the “Payment Amount” input field.
Enter “N” in the “Overdue Status” input field.
Click the “Save” button.
Verify that the data has been successfully saved.

In S30, when the test scenario is generated as described above, each test code according to the test scenario may be generated. That is, a test case corresponding to the test scenario is generated. The generated test case may be modified.

A method of generating the test case may include manual generation, recording generation, user behavior-based AI learning automatic generation, and the like. The manual generation is a method in which a user directly writes a script. The recording generation is a method of writing a test case through a recording function while performing a test. The user behavior-based AI learning automatic generation is a method of automatically generating a test case using AI (artificial intelligence) based on a user's test behavior (i.e., user behavior).

In S40, when the test case is generated, the test scenario is executed according to the generated test case.

In S50, the execution result may be output through a dashboard so that the user can check it.

In this embodiment, various browsers can be supported. Also, web testing on various devices (PC, Mobile, Tablet, etc.) can be supported. Integration with various third-party CI/CD tools may be enabled, and automated tests may be incorporated into CI/CD pipelines to automate regression testing. Furthermore, scenario-based test cases may be extended, and diverse statistics relating to test coverage may be output through a dashboard.

Hereinafter, the user behavior-based AI learning automatic generation among the test case generation processes performed in the test studio 4 will be described with reference to related drawings.

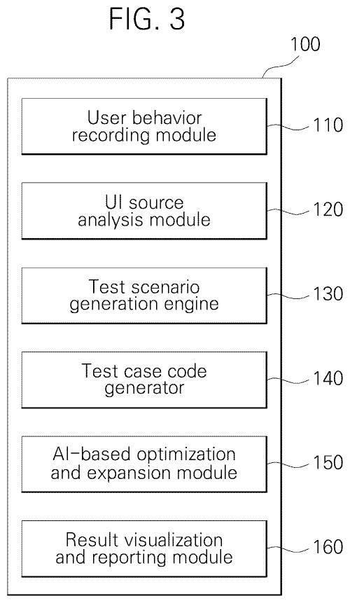

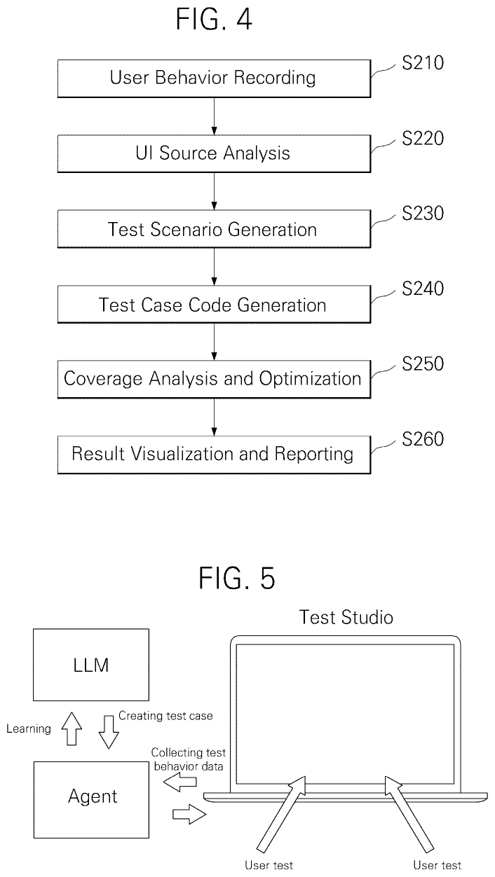

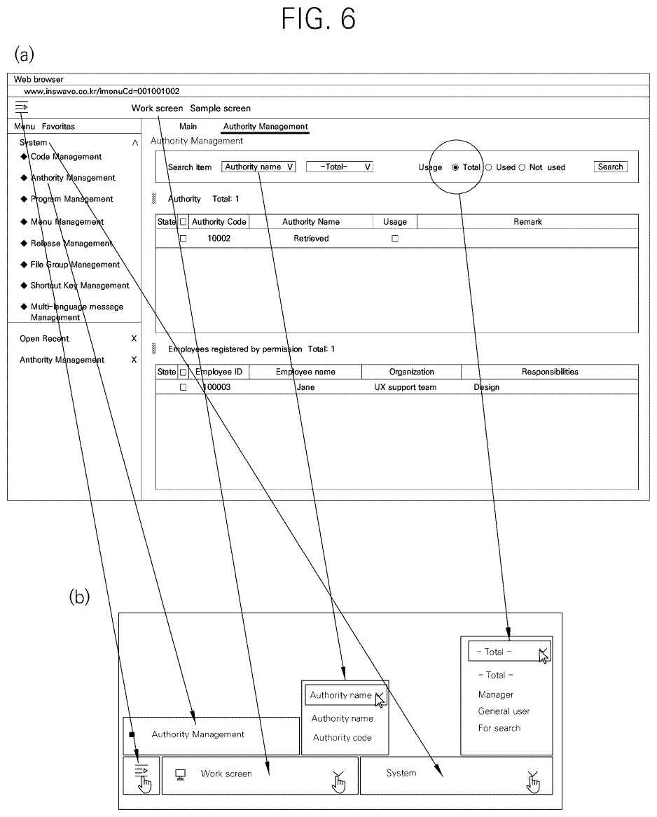

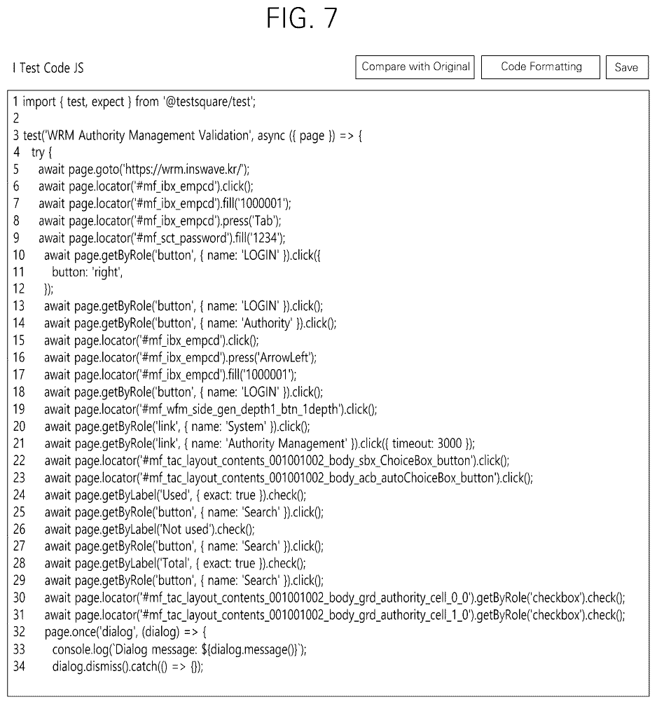

FIG. 3 exemplarily illustrates a user behavior-based AI test code generation system according to one embodiment of the present invention, FIG. 4 is a flowchart of a user behavior-based AI test code generation method according to one embodiment of the present invention, FIG. 5 exemplarily illustrates a process of generating a user behavior-based AI test code, and FIGS. 6 and 7 exemplarily illustrate a test target screen, recorded user behavior data, and a written AI test code.

The user behavior-based AI test code generation system 100 according to one embodiment of the present invention is a system belonging to the test studio 4, and is characterized in that it can automatically generate a test code (i.e., a test script) by utilizing artificial intelligence based on actual operations of a user.

The user behavior-based AI test code generation system 100 according to this embodiment may include a user behavior recording module 110, a UI source analysis module 120, a test scenario generation engine 130, and a test case code generation module 140. Also, the system 100 may further include at least one of an AI-based optimization and expansion module 150 and a result visualization and reporting module 160.

In S210, the user behavior recording module 110 may be configured to record UI interactions related to user behavior on the execution screen of software to be tested. The user behavior may include a mouse click, a keyboard input, a touch, a gesture, and the like, and such user behavior may be precisely recorded.

The user behavior recording module 110 may be configured to collect detailed information of at least one of coordinates, pressure, speed, timestamp, and the like of each action.

Also, the user behavior recording module 110 may be configured to synchronize and record screen state changes and system responses.

In S220, the UI source analysis module 120 may be configured to parse and analyze UI source codes of the software. The UI source codes may be at least one of HTML, CSS, Javascript, and the like.

The UI source analysis module 120 may be configured to extract and map a structure, an attribute, an event handler, and the like of a UI element constituting the execution screen. In addition, the UI source analysis module 120 may be configured to automatically detect and analyze changes in the UI, and support automatic updating of test code.

In S230, the test scenario generation engine 130 may be configured to receive the recorded user behavior and the analysis result of the UI source as input and processes them.

The test scenario generation engine 130 may be configured to utilize natural language processing (NLP) techniques to understand the intent and context of user behaviors. In this process, a separately prepared large language model (LLM) may be employed to facilitate the understanding of the intent and context of the user actions.

And by utilizing a Recurrent Neural Network (RNN) and a transformer model, a sequence of the user behavior may be analyzed, and a meaningful test scenario may be extracted.

Also, the test scenario generation engine 130 may be configured to determine a priority of the test scenario by analyzing a pattern and an intention of the user behavior.

For example, when testing an initial screen of a mobile banking application, the actual layout of the screen and frequently used menus may not match. In such a case, by referring to user behaviors, the test scenario may be generated to more accurately reflect real-world situations.

In S240, the test case code generation module 140 may be configured to convert the generated test scenario into an executable test code. Code suitable for various testing frameworks such as Selenium, Cypress, Jest, and the like can be automatically generated.

Assertion logic can be automatically added to verify the validity of the test.

A test assertion is an expression included in the test code to verify that the program behaves as expected. The test assertion serves to verify that a specific condition or result of the code matches an expectation. The test assertion examines whether a given condition is true, and may generate an error if the condition is false.

For example, the following code may be the test assertion code.
const {test, expect}=require(‘@playwright/test’);
test(‘example test with assertions’, async ({page})=>{
// Go to web page
await page.goto(‘https://example.com’);
// Check title
await expect(page).toHaveTitle(‘Example Domain’);
// Check text content
const heading=page.locator(‘h1’);
await expect(heading).toHaveText(‘Example Domain’);
// Check component existence
const paragraph=page.locator(‘p’);
await expect(paragraph).toBeVisible( );
// Check URL
await expect(page).toHaveURL(‘https://example.com/’);
// Check component count
const links=page.locator(‘a’);
await expect(links).toHaveCount(1);
// Check attribute value
const link=page.locator(‘a’);
await expect(link).toHaveAttribute(‘href’, ‘https://www.iana.org/domains/example’);
});

Also, the test case code generation module 140 may be configured to optimize the code considering readability and maintainability of the generated code.

In S250, the AI-based optimization and expansion module 150 may be configured to analyze and optimize a coverage of the generated test case. Coverage is a measure indicating how much of the source code is executed by the software test. At least one of a ratio of executed code lines and a ratio of called functions may be used as the coverage.

Also, the AI-based optimization and expansion module 150 may be configured to utilize a reinforcement learning algorithm (e.g., Deep Q-Network) to generate an unexpected user scenario. And by continuously learning test execution results and actual user data, the quality and diversity of test cases can be improved.

When a new UI component or function is added, a relevant test case may be automatically generated.

In S260, the result visualization and reporting module 160 may be configured to intuitively visualize the generated test scenario and case. Also, a report can be automatically generated by synthesizing test execution results.

To this end, the result visualization and reporting module 160 may be configured to provide a dashboard interface that can be easily understood and utilized by users (e.g., developers and/or QA teams). Through a real-time notification function, important test results or issues can be immediately delivered to relevant users.

Referring to FIG. 6, (a) a software execution screen to be tested, and (b) user behavior data recorded according to the actions of a user participating in the test are illustrated.

A series of user behaviors performed by the test participants during the testing of the software execution screen (a) may be recorded at the level of UI components (b).

In the manual approach, the user must directly write the test code, and in the recording approach, the entire test execution process of the user is recorded, requiring the user to replicate the recorded actions step by step, which is cumbersome.

However, in this embodiment where the test code is generated through AI learning based on user behavior, it is sufficient to record UI components corresponding to a series of user behaviors involved in the test. After that, the recorded UI elements are refined to request the LLM to generate a test case, and the artificial intelligence generates the test case.

An example of the generated test case code is shown in FIG. 7. Through a UI mode, it is possible to verify whether the generated test case operates correctly. The UI mode is a mode showing the test executed according to the generated code through the UI screen of the software.

The system 100 according to this embodiment may be configured to collect and analyze data based on actual user behavior. Various user scenarios can be generated by automatically generating learning-based AI test cases.

And test cases can be dynamically updated. When a test case changes, AI can analyze the existing test case and automatically update it.

Test case may be expanded based on interactions. And data-based test case diversification can be achieved. Adaptive UI test cases may also be generated.

Both private LLM and public LLM can be supported.

According to this embodiment, test writing time and costs can be reduced. Manual work can be minimized by automatically converting user behavior into test code.

Testing based on actual user behavior can be possible. Test cases that accurately reflect various interaction patterns of actual users can be generated. And user behavior on various devices, browsers, and operating systems can be comprehensively tested.

Flexible response to UI changes can be possible. Through UI source analysis, test codes can be automatically updated when the UI changes. Test cases for new UI components or functions can be automatically generated and integrated.

And test coverage can be improved. Unexpected scenarios and edge cases can be discovered and tested by utilizing AI. Complex interaction scenarios can be generated through reinforcement learning to perform more in-depth tests.

Also, continuous improvement can be achieved. Through machine learning algorithms, the quality of test cases can be continuously improved. By learning actual user data and test results, new usage patterns or bug patterns can be automatically detected and responded to. Test strategies can be automatically adjusted and optimized as the software evolves.

Intelligent reporting can be possible. Actionable insights can be provided to the development team by deeply analyzing test results. High-priority issues can be automatically identified and notified to relevant teams in real time.

This embodiment suggests a new paradigm of test automation in the software development process, and will greatly contribute to improvement of development productivity and software quality. In particular, by implementing a test system that continuously evolves utilizing AI technology, it is possible to effectively respond to a rapidly changing software development environment.

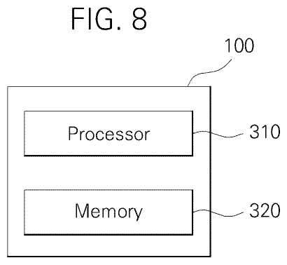

FIG. 8 exemplarily illustrates a configuration of a system according to one embodiment of the present invention.

Referring to FIG. 8, the system 100 may include a processor 310 and a memory 320. The memory 320 may store one or more instructions executable by the processor 310. The processor 310 may execute the one or more instructions stored in the memory 320. The processor 310 may execute the one or more operations described above by executing the instructions. In addition, the configuration of the present invention described above with reference to FIG. 3 may be a configuration implemented by instructions executed by the processor 310.

The embodiments described above may be implemented by hardware components, software components, and/or a combination of hardware components and software components. For example, the devices, methods, and components described in the embodiments may be implemented using one or more general-purpose computers or special-purpose computers, such as, for example, a processor, a controller, a Central Processing Unit (CPU), a Graphics Processing Unit (GPU), an Arithmetic Logic Unit (ALU), a Digital Signal Processor (DSP), a microcomputer, a Field Programmable Gate Array (FPGA), a Programmable Logic Unit (PLU), a microprocessor, Application Specific Integrated Circuits (ASICS), or any other device capable of executing and responding to instructions.

The above-described user behavior-based AI test code generation method may also be implemented in the form of a recording medium including instructions executable by a computer, such as an application or program module executed by a computer. The computer-readable medium can be any available medium that can be accessed by a computer and includes both volatile and nonvolatile media, removable and non-removable media. In addition, the computer-readable medium may include a computer storage medium. The computer storage medium includes both volatile and nonvolatile, removable and non-removable media implemented in any method or technology for storage of information such as computer readable instructions, data structures, program modules or other data.

The above-described user behavior-based AI test code generation method may be executed by an application (which may include a program included in a platform or operating system by default installed in the terminal) installed by default in the terminal, and by an application (i.e., program) that a user manually installed in the terminal after downloading from an application store server, or an application providing server such as a web server related to the application or service. In this sense, the above-described user behavior-based AI test code generation method may be implemented as an application (i.e., program) installed by default in the terminal or manually installed by a user, and may be recorded in the non-transitory computer-readable recording medium such as the terminal.

While the invention has been described above with reference to exemplary embodiments, it will be understood by those skilled in the art that the invention can be modified and changed in various forms without departing from the concept and scope of the invention described in the appended claims.

What is claimed is:

1. A non-transitory computer-readable medium storing computer executable instructions for performing a user behavior-based AI test code generation method when executed by a computer, wherein the computer program causes the computer to perform the following steps:
recording a UI interaction related to a user behavior on an execution screen of software to be tested;
analyzing a UI source of the software;
inputting the recorded user behavior and an analysis result of the UI source to generate a test scenario through an LLM; and
converting the test scenario into a test code corresponding to an executable test case.

2. The non-transitory computer-readable medium of claim 1, wherein in the step of generating the test scenario, a sequence of the user behaviors is analyzed by utilizing a Recurrent Neural Network (RNN) and a transformer model, and the meaningful test scenario is extracted.

3. The non-transitory computer-readable medium of claim 2, wherein in the step of generating the test scenario, an intention and a context of the user behavior are understood using a natural language processing technique.

4. The non-transitory computer-readable medium of claim 3, wherein in the step of generating the test scenario, a priority of the test scenario is determined by analyzing a pattern and the intention of the user behavior.

5. The non-transitory computer-readable medium of claim 1, wherein in the step of analyzing the UI source, at least one of a structure, an attribute, and an event handler of an UI component constituting the execution screen is extracted, mapped to a UI source code, parsed, and analyzed.

6. The non-transitory computer-readable medium of claim 1, wherein the user behavior comprises at least one of a mouse click, a keyboard input, a touch, and a gesture,
wherein the step of recording the user behavior collects detailed information of at least one of coordinates, pressure, speed, and timestamp of each action according to the user behavior.

7. The non-transitory computer-readable medium of claim 1, further comprising:
analyzing and optimizing a coverage of the test case, and utilizing a reinforcement learning algorithm to generate an unexpected user scenario to be tested.

8. The non-transitory computer-readable medium of claim 7, wherein the coverage is at least one of a ratio of executed code lines and a ratio of called functions.

9. The non-transitory computer-readable medium of claim 7, further comprising at least one of:
visualizing the generated test scenario and the test case; and
outputting a test execution result through a dashboard interface.

10. A user behavior-based AI test code generation system, comprising:
a user behavior recording module configured to record a UI interaction related to a user behavior on an execution screen of software to be tested;
a UI source analysis module configured to analyze a UI source of the software;
a test scenario generation engine configured to input the recorded user behavior and an analysis result of the UI source to generate a test scenario through an LLM; and
a test case code generation module configured to convert the test scenario into a test code corresponding to an executable test case.

11. The user behavior-based AI test code generation system of claim 10, further comprising:
an AI-based optimization and expansion module configured to analyze and optimize a coverage of the test case, and utilize a reinforcement learning algorithm to generate an unexpected user scenario to be tested.

12. The user behavior-based AI test code generation system of claim 11, further comprising:
a result visualization and reporting module configured to visualize the generated test scenario and the test case, and output a test execution result through a dashboard interface.
